(19) United States
(12) Patent Application Publication
(10) Pub. No.: US 2022/0180664 A1
(43) Pub. Date: Jun. 9, 2022

(54) FRAME OF REFERENCE FOR MOTION CAPTURE

(71) Applicant: Sony Interactive Enterainment LLC, San Mateo, CA (US)

(72) Inventors: Derek Crosby, San Mateo, CA (US); Charles Ghislandi, San Mateo, CA (US); Geoff Wedig, San Mateo, CA (US)

(21) Appl. No.: 17/535,623

(22) Filed: Nov. 25, 2021

Related U.S. Application Data
(60) Provisional application No. 63/118,905, filed on Nov. 28, 2020.

(51) Int. Cl. G06V 40/20; G02B 27/01; G06T 7/73; G02B 27/00

(52) U.S. Cl. CPC G06V 40/23; G02B 27/017; G02B 2027/0169; G02B 27/0093; G02B 27/0179; G06T 7/73

(57) ABSTRACT

Techniques are described for facilitating the coordination of audio video (AV) production using multiple actors in respective locations that are remote from each other, such that an integrated AV product can be generated by coordinating the activities of multiple remote actors in concert with one another. Motion capture (mocap) of multiple actors who are geographically distant from each other is facilitated.

### FIELD

The application relates generally to technically inventive, non-routine solutions that are necessarily rooted in computer technology and that produce concrete technical improvements. In particular, the present application relates to techniques for enabling collaborative remote acting in multiple locations.

### BACKGROUND

Owing to health and cost concerns, people increasingly collaborate together from remote locations. As understood herein, collaborative movie and computer simulation (e.g., computer game) generation using remote actors can pose unique coordination problems because a director must direct multiple actors each potentially in his or her own studio or sound stage in making movies and for computer simulation-related activities such as motion capture (MoCap). For example, challenges exist in providing remote actors physical references on their individual stages in a manner that action is coordinated. Present principles provide techniques for addressing some of these coordination challenges.

### SUMMARY

Present principles thus provide a method that includes providing at least a first actor at a first location with a frame of reference while filming the first actor for motion capture (mocap) at least in part by presenting at least one reference image on a head-mounted display (HMD) worn by the first actor. The light reflected from the retroreflectors may be from a light emitter. In addition, or alternatively, the method may include providing retroreflectors on a wall of the first location for reflecting light toward the first actor. In addition, or alternatively, the method may include providing visible markers on a floor of the first location.

In some examples, the method may include providing at least a second actor at a second location with a frame of reference while filming the second actor for mocap. The first location can be geographically distant from the second location, and mocap from the first and second actors can be presented on at least one director display communicating with the first and second locations in a web exercise (WebEx).

The first actor may be provided with a frame of reference at least in part using audio played at the first location. Plural light emitters may be provided on the HMD. Mocap video of the first and second actors can be synchronized in time.

In another aspect, a device includes at least one computer storage that is not a transitory signal and that in turn includes instructions executable by at least one processor to receive from a first camera at a first location motion capture (mocap) video of a first actor. The instructions are executable to receive from a second camera at a second location mocap video of a second actor, synchronize the mocap videos with each other, and merge the mocap videos into a single scene on at least one display at a third location geographically distant from the first and second locations.

In another aspect, an apparatus includes at least one head-mounted display (HMD) assembly which in turn includes at least one processor configured with instructions and at least one display controlled by the processor. The HMD may also include a speaker. At least one projector is configured to project motion capture (mocap) reference light against at least one surface visible to a wearer of the HMD assembly to provide the wearer with spatial reference during mocap.

The details of the present application, both as to its structure and operation, can best be understood in reference to the accompanying drawings, in which like reference numerals refer to like parts, and in which:

### BRIEF DESCRIPTION OF THE DRAWINGS

FIG. 1 is a block diagram of an example system consistent with present principles;

FIG. 2 illustrates example logic in example flow chart format consistent with present principles;

FIG. 3 illustrates a screen shot of an example stage display;

FIG. 4 illustrates an example distributed acting environment showing for illustration two remote studios or film sets and a remote director computer presenting video from each set or studio;

FIG. 5 illustrates a camera on a boom of a head-mounted display (HMD) for illuminating retroreflectors on a wall of a film set;

FIG. 6 illustrates further features of the retroreflectors;

FIG. 7 illustrates additional example logic in example flow chart format consistent with present principles;

FIG. 8 illustrates markers on a floor of a film set to aid an actor in the film set;

FIG. 9 illustrates additional example logic in example flow chart format consistent with present principles; and

FIG. 10 illustrates a screen shot on an example HMD.

### DETAILED DESCRIPTION

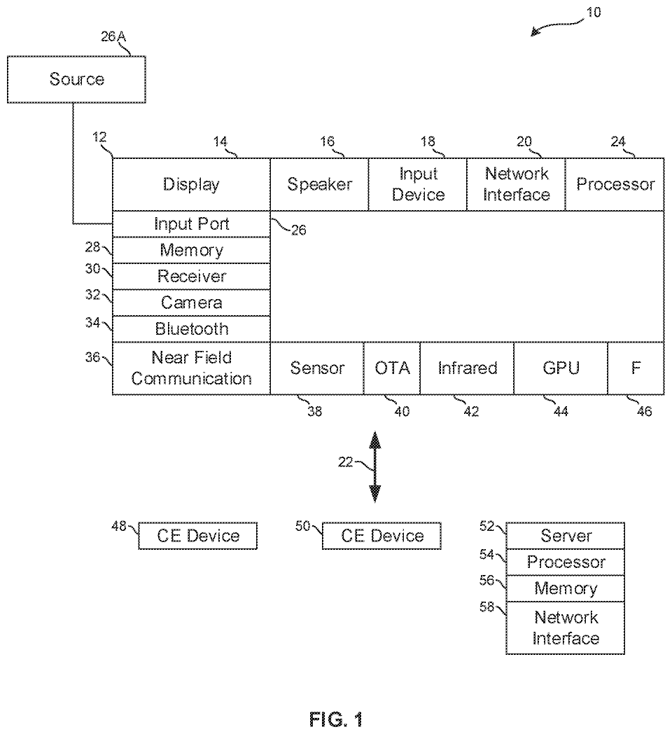

Now referring to FIG. 1, this disclosure relates generally to computer ecosystems including aspects of computer networks that may include consumer electronics (CE) devices. A system herein may include server and client components, connected over a network such that data may be exchanged between the client and server components. The client components may include one or more computing devices including portable televisions (e.g., smart TVs, Internet-enabled TVs), portable computers such as laptops and tablet computers, and other mobile devices including smart phones and additional examples discussed below. These client devices may operate with a variety of operating environments. For example, some of the client computers may employ, as examples, operating systems from Microsoft, or a Unix operating system, or operating systems produced by Apple Computer or Google. These operating environments may be used to execute one or more browsing programs, such as a browser made by Microsoft or Google or Mozilla or other browser program that can access websites hosted by the Internet servers discussed below.

Servers and/or gateways may include one or more processors executing instructions that configure the servers to receive and transmit data over a network such as the Internet. Or, a client and server can be connected over a local intranet or a virtual private network. A server or controller may be instantiated by a game console such as a Sony PlayStation®, a personal computer, etc.

Information may be exchanged over a network between the clients and servers. To this end and for security, servers and/or clients can include firewalls, load balancers, temporary storages, and proxies, and other network infrastructure for reliability and security.

As used herein, instructions refer to computer-implemented steps for processing information in the system. Instructions can be implemented in software, firmware or hardware and include any type of programmed step undertaken by components of the system.

A processor may be a general-purpose single- or multi-chip processor that can execute logic by means of various lines such as address lines, data lines, and control lines and registers and shift registers.

Software modules described by way of the flow charts and user interfaces herein can include various sub-routines, procedures, etc. Without limiting the disclosure, logic stated to be executed by a particular module can be redistributed to other software modules and/or combined together in a single module and/ or made available in a shareable library. While flow chart format may be used, it is to be understood that software may be implemented as a state machine or other logical method.

Present principles described herein can be implemented as hardware, software, firmware, or combinations thereof; hence, illustrative components, blocks, modules, circuits, and steps are set forth in terms of their functionality.

Further to what has been alluded to above, logical blocks, modules, and circuits described below can be implemented or performed with a general-purpose processor, a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can be implemented by a controller or state machine or a combination of computing devices.

The functions and methods described below, when implemented in software, can be written in an appropriate language such as but not limited to C# or C++, and can be stored on or transmitted through a computer-readable storage medium such as a random access memory (RAM), read-only memory (ROM), electrically erasable programmable read-only memory (EEPROM), compact disk read-only memory (CD-ROM) or other optical disk storage such as digital versatile disc (DVD), magnetic disk storage or other magnetic storage devices including removable thumb drives, etc. A connection may establish a computer-readable medium. Such connections can include, as examples, hard-wired cables including fiber optics and coaxial wires and digital subscriber line (DSL) and twisted pair wires.

Components included in one embodiment can be used in other embodiments in any appropriate combination. For example, any of the various components described herein and/or depicted in the Figures may be combined, interchanged, or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

Now specifically referring to FIG. 1, an example system 10 is shown, which may include one or more of the example devices mentioned above and described further below in accordance with present principles. Note that computerized devices described in the figures herein may include some or all of the components set forth for various devices in FIG. 1.

The first of the example devices included in the system 10 is a consumer electronics (CE) device configured as an example primary display device, and in the embodiment shown is an audio video display device (AVDD) 12 such as but not limited to an Internet-enabled TV with a TV tuner (equivalently, set top box controlling a TV). The AVDD 12 may be an Android®-based system. The AVDD 12 alternatively may also be a computerized Internet enabled (“smart”) telephone, a tablet computer, a notebook computer, a wearable computerized device such as e.g., computerized Internet-enabled watch, a computerized Internet-enabled bracelet, other computerized Internet-enabled devices, a computerized Internet-enabled music player, computerized Internet-enabled headphones, a computerized Internet-enabled implantable device such as an implantable skin device, etc. Regardless, it is to be understood that the AVDD 12 and/or other computers described herein is configured to undertake present principles (e.g., communicate with other CE devices to undertake present principles, execute the logic described herein, and perform any other functions and/or operations described herein).

Accordingly, to undertake such principles the AVDD 12 can be established by some, or all of the components shown in FIG. 1. For example, the AVDD 12 can include one or more displays 14 that may be implemented by a high definition or ultra-high definition “4K” or higher flat screen and that may or may not be touch-enabled for receiving user input signals via touches on the display. The AVDD 12 may also include one or more speakers 16 for outputting audio in accordance with present principles, and at least one additional input device 18 such as e.g., an audio receiver/microphone for e.g., entering audible commands to the AVDD 12 to control the AVDD 12. The example AVDD 12 may further include one or more network interfaces 20 for communication over at least one network 22 such as the Internet, other wide area network (WAN), a local area network (LAN), a personal area network (PAN), etc. under control of one or more processors 24. Thus, the interface 20 may be, without limitation, a Wi-Fi transceiver, which is an example of a wireless computer network interface, such as but not limited to a mesh network transceiver. The interface 20 may be, without limitation a Bluetooth transceiver, Zigbee transceiver, IrDA transceiver, Wireless USB transceiver, wired USB, wired LAN, Powerline or MoCA. It is to be understood that the processor 24 controls the AVDD 12 to undertake present principles, including the other elements of the AVDD 12 described herein such as e.g., controlling the display 14 to present images thereon and receiving input therefrom. Furthermore, note the network interface 20 may be, e.g., a wired or wireless modem or router, or other appropriate interface such as, e.g., a wireless telephony transceiver, or Wi-Fi transceiver as mentioned above, etc.

In addition to the foregoing, the AVDD 12 may also include one or more input ports 26 such as, e.g., a high-definition multimedia interface (HDMI) port or a USB port to physically connect (e.g., using a wired connection) to another CE device and/or a headphone port to connect headphones to the AVDD 12 for presentation of audio from the AVDD 12 to a user through the headphones. For example, the input port 26 may be connected via wire or wirelessly to a cable or satellite source 26a of audio video content. Thus, the source 26a may be, e.g., a separate or integrated set top box, or a satellite receiver. Or, the source 26a may be a game console or disk player.

The AVDD 12 may further include one or more computer memories 28 such as disk-based or solid-state storage that are not transitory signals, in some cases embodied in the chassis of the AVDD as standalone devices or as a personal video recording device (PVR) or video disk player either internal or external to the chassis of the AVDD for playing back AV programs or as removable memory media. Also, in some embodiments, the AVDD 12 can include a position or location receiver such as but not limited to a cellphone receiver, GPS receiver and/or altimeter 30 that is configured to e.g., receive geographic position information from at least one satellite or cellphone tower and provide the information to the processor 24 and/or determine an altitude at which the AVDD 12 is disposed in conjunction with the processor 24. However, it is to be understood that that another suitable position receiver other than a cellphone receiver, GPS receiver and/or altimeter may be used in accordance with present principles to e.g., determine the location of the AVDD 12 in e.g., all three dimensions.

Continuing the description of the AVDD 12, in some embodiments the AVDD 12 may include one or more cameras 32 that may be, e.g., a thermal imaging camera, a digital camera such as a webcam, and/or a camera integrated into the AVDD 12 and controllable by the processor 24 to gather pictures/images and/or video in accordance with present principles. Also included on the AVDD 12 may be a Bluetooth transceiver 34 and other Near Field Communication (NFC) element 36 for communication with other devices using Bluetooth and/or NFC technology, respectively. An example NFC element can be a radio frequency identification (RFID) element.

Further still, the AVDD 12 may include one or more auxiliary sensors 38 (e.g., a motion sensor such as an accelerometer, gyroscope, cyclometer, or a magnetic sensor, an infrared (IR) sensor for receiving IR commands from a remote control, an optical sensor, a speed and/or cadence sensor, a gesture sensor (e.g., for sensing gesture command), etc.) providing input to the processor 24. The AVDD 12 may include an over-the-air TV broadcast port 40 for receiving OTA TV broadcasts providing input to the processor 24. In addition to the foregoing, it is noted that the AVDD 12 may also include an infrared (IR) transmitter and/or IR receiver and/or IR transceiver 42 such as an IR data association (IRDA) device. A battery (not shown) may be provided for powering the AVDD 12.

Still further, in some embodiments the AVDD 12 may include a graphics processing unit (GPU) 44 and/or a field-programmable gate array (FPGA) 46. The GPU and/or FPGA may be utilized by the AVDD 12 for, e.g., artificial intelligence processing such as training neural networks and performing the operations (e.g., inferences) of neural networks in accordance with present principles. However, note that the processor 24 may also be used for artificial intelligence processing such as where the processor 24 might be a central processing unit (CPU).

Still referring to FIG. 1, in addition to the AVDD 12, the system 10 may include one or more other computer device types that may include some or all of the components shown for the AVDD 12. In one example, a first device 48 and a second device 50 are shown and may include similar components as some or all of the components of the AVDD 12. Fewer or greater devices may be used than shown.

The system 10 also may include one or more servers 52. A server 52 may include at least one server processor 54, at least one computer memory 56 such as disk-based or solid-state storage, and at least one network interface 58 that, under control of the server processor 54, allows for communication with the other devices of FIG. 1 over the network 22, and indeed may facilitate communication between servers, controllers, and client devices in accordance with present principles. Note that the network interface 58 may be, e.g., a wired or wireless modem or router, Wi-Fi transceiver, or other appropriate interface such as, e.g., a wireless telephony transceiver.

Accordingly, in some embodiments the server 52 may be an Internet server and may include and perform “cloud” functions such that the devices of the system 10 may access a “cloud” environment via the server 52 in example embodiments. Or, the server 52 may be implemented by a game console or other computer in the same room as the other devices shown in FIG. 1 or nearby.

The devices described below may incorporate some or all of the elements described above.

“Geographically distant” refers to locations that are beyond sight and sound of each other, typically separated from each other by a mile or more.

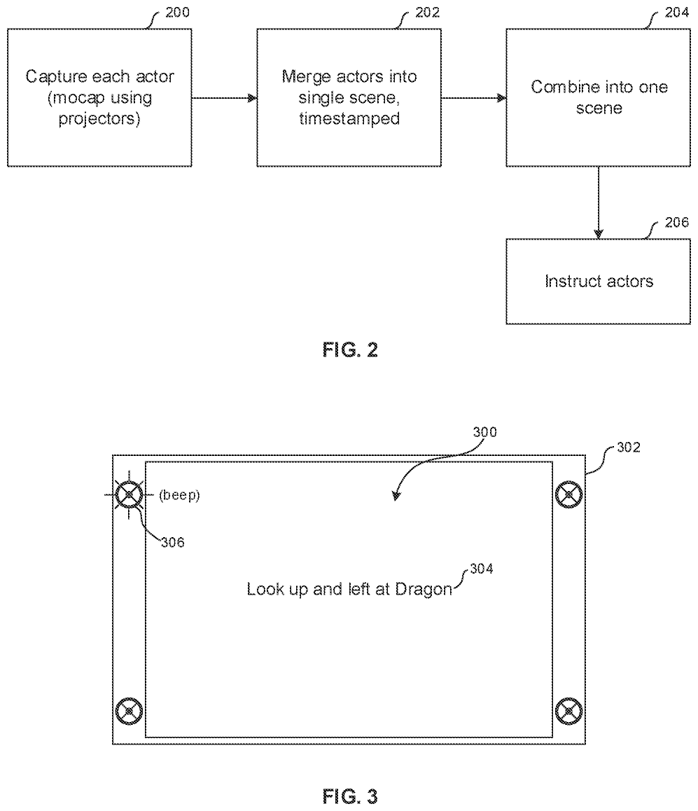

FIG. 2 illustrates example logic in example flow chart format consistent with present principles. Essentially, projectors are used for motion capture (mocap) and to track mocap of the point of view (POV) of multiple actors on multiple, geographically distant stages, performing position tracking for fidelity.

Commencing at block 200, the movements of each of plural actors in their respective stages or other locations is captured using, e.g., projectors to reflect light from reflective tags or other markers borne by the actors. Video images of each actor's mocap data is merged at block 202 into a single scene using, e.g., timestamps appended to the frames of each actor's mocap to align frames in time with each other in real world time or in video scene time. The mocap of multiple actors is combined into a single scene at block 204 and as this occurs in real time or near real time as the actors are being filmed, a director can instruct actors at block 206 by giving them stage directions as discussed at greater length below.

Indeed, FIG. 3 illustrates a screen shot 300 of an example stage display 302 that can be mounted on a sound stage or other filming location in view of an actor as the actor acts for mocap. A text stage direction 304 may be presented on the display to prompt the actor to a certain action, e.g., look up and to the left to a virtual location of a dragoon in a video. An audio prompt such as a beep or voice direction may be emitted by one or more speakers 306 to the same effect, e.g., beeping from a speaker located at the upper left corner of the display. In this way, mocap actors may look at monitors lining a motion capture stage, so they see themselves and the animation they're reacting to (e.g., to not run into person or wall in animation).

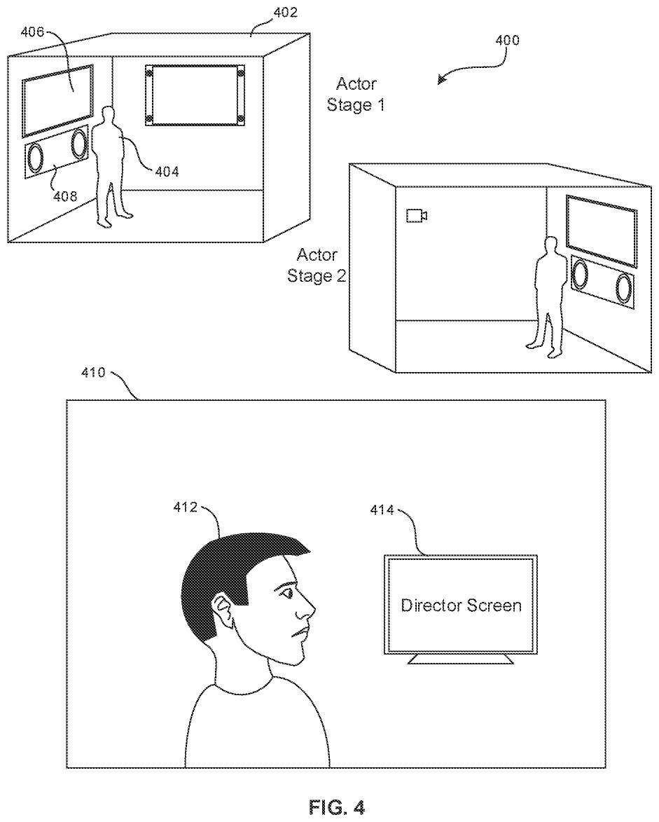

FIG. 4 illustrates an example distributed acting environment 400 showing for illustration two remote studios or film sets 402 in which one or more respective actors 404 are acting for mocap purposes. One or more displays 406 and/or speakers 408 may be mounted in the studios 402 as shown and may be instantiated by, e.g., the display 302 shown in FIG. 3. Video feeds of the actors 404 may be sent via wired and/or wireless paths of, for instance, a wide area network (WAN) in a Web exercise (WebEx)-style feeds to a director location 410 remote from the studios or sets 402 at which a person 412 such as a director or quality control (QC) technician can operate a director computer 414 presenting video from each set or studio 402.

Thus, FIG. 4 illustrates that multiple stages/studios can be used to capture actor mocap videos that are streamed to one virtual reality (VR) world for consolidation of each stream into a single video at the director computer 414. This facilitates creating large scenes of multiple people based on actors who are geographically remote from each other, and in particular is useful for aggregating body motion capture of multiple actors on respective multiple stages.

An operator/leader (QC operator) to combine the mocap videos can be in the location 410 that is remote from the stages 402 using, for instance, a virtual private network (VPN) to network. Remote access software can be used to move the mocap videos into a QC computer 414 that can feed backstage directions and other information such as whether a remote camera was bumped, another take is required, etc.

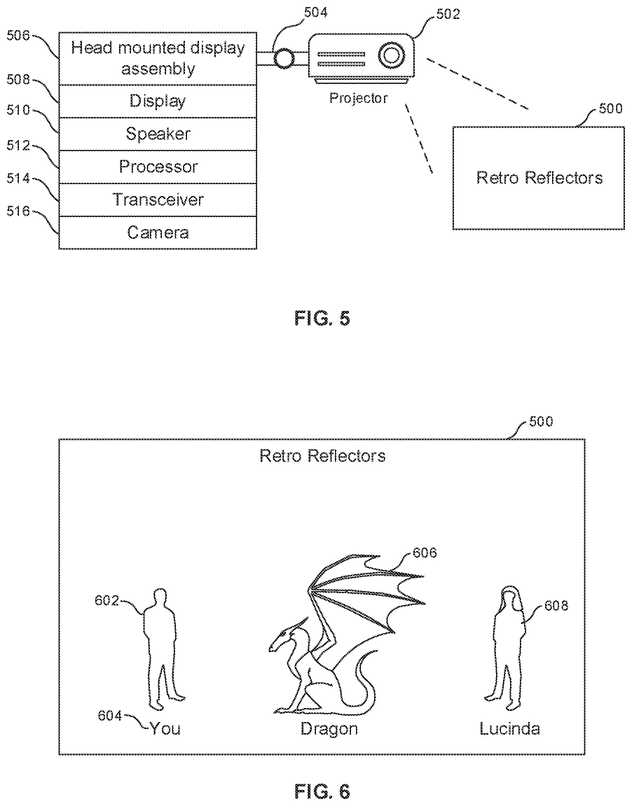

FIG. 5 illustrates a wall of retroreflectors 500 arranged, e.g., in a grid that can be illuminated by one or more projectors 502 mounted by means of one or more booms 504 to a head-mounted display (HMD) 506 of a mocap actor for illuminating the retroreflectors, which may be applied to a wall of a film set 402. This gives the mocap actor wearing the HMD 506 a reference point in the real world as he views reflections of the projector from the retroreflectors 500 through the HMD display 508. One or more speakers 510 may be provided on the HMD and output of the HMD including control of the projector 502 may be effected by one or more processors 512 accessing one or more transceivers 514.

The “wall” of retro-reflective material 500 and projector 502 on the HMD 506 gives different actors different frames of reference relative to the wall. Only the person wearing the HMD 506 can see the projection reflections from his point of view. In this way, using a wall of retro-reflective material 500, virtual set actors can see necessary references without getting in the way of each other, viewing reference reflections that are aligned.

It is to be understood that the HMD 506 may include one or more internal cameras 516 to track head and eye of the wearer to better resolve what the actor would see in the virtual environment, feeding that scene to the projector 502 for projection of appropriate images onto the retroreflectors 500.

FIG. 6 illustrates further features of the retroreflectors 500, in which a HMD projector such as the projector 502 in FIG. 5 has projected various images from an existing virtual scene into which the actor mocap is to be combined. An image 602 of the actor may be projected onto the retroreflectors 500 for viewing of the image of the actor, along with visible or audible identifications 604 of the various images. In the example of FIG. 6, an image 606 of a dragon is projected at the location in the virtual world the dragon is emulated to be, along with an image 608 of another character-based actor using mocap video from the other actor.

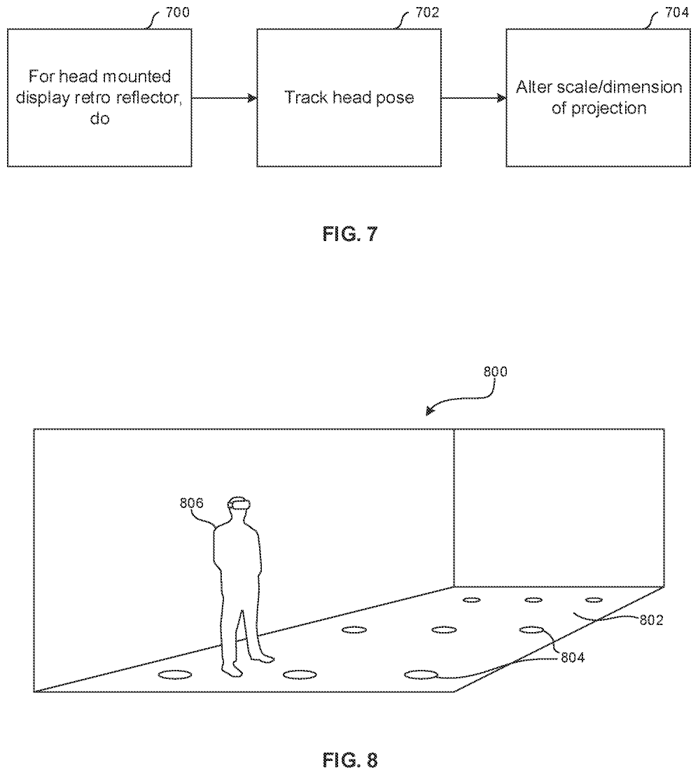

FIG. 7 illustrates additional example logic in example flow chart format consistent with an embodiment in which the reference projections are presented on the display of the HMD 506. Commencing at block 700, for a HMD with internal visible retroflectors, head and eye pose may be tracked at block 702 based on images from internal cameras of the HMD. Proceeding to block 704, the scale and dimension of projected images on the HMD 506, derived from an existing video of a virtual scene, may be altered based on the head/eye tracking at block 702. In this way, an actor can look up toward an image of the head of a character emulated to be taller than the actor or look down at an image of a character emulated to be shorter than the actor.

Or, FIG. 8 illustrates a stage set 800 with a floor 802 having retroreflective markers 804 on which an actor 806 can walk, with a projector on a HMD or elsewhere in the stage set 800 projecting images onto the markers 804 to aid the actor 806 in navigating virtual objects in the film set during mocap. It is to be appreciated that the techniques discussed above provide pre-canned animation or video that mocap actors can act against.

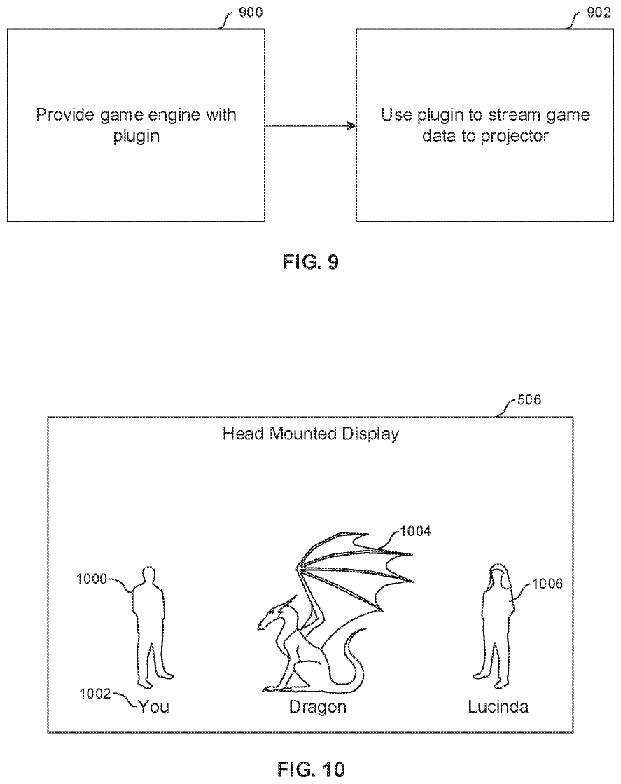

FIG. 9 illustrates additional example logic that at block 900 uses a computer game engine with a plugin computer program to stream game data to the plugin, which in turn automatically sends the game data, including audio and video, to any of the projectors herein for presentation of reference images to aid mocap actors in their acting.

FIG. 10 illustrates a screen shot on an example HMD 506. Similar to the external wall of retroreflectors 500 shown in FIGS. 5 and 6, internal projectors in the HMD 506 may project onto the display of the HMD an image 1000 of the actor for viewing of the image of the actor, along with visible or audible identifications 1002 of the various images. In the example of FIG. 10, an image 1004 of a dragon is projected at the location in the virtual world the dragon is emulated to be, along with an image 1006 of another character-based actor using mocap video from the other actor. The display of the HMD may be a reflective surface such as a visor on HMD that is be used for projection, with head tracking used to get the dimensions and scales of the various images correct.

Whether projected onto a wall or floor or HMD components, characters such as the above-mentioned dragon can be part of a reference video and viewed by actors as being in the same location in VR space on different, geographically remote stages. Also, by sending the mocap feed of one actor to the display of the other, remote actor, both actors can receive a presence of the other actor on another stage with the same dragon and in-person actor. Each actor is thus captured on video, which is sent to the unreal virtual representation that merges virtual characters such as the dragon with mocap video of real actors into single scene. In this way, people on every stage can see the same combined scene and make appropriate adjustments. Regardless of what an actor is supposed to react to—another actor or pre-canned character—a screen or cage system gives the actor an indication of where to look.

Thus, the problem being solved is giving actors physical references on the stage. Audio being played can be cues to actors as well.

In the above examples, reference images can be stabilized by transforming images based on head movement of the mocap actor. Also, just prior to the appearance of a character in the VR world, audible alerts such as “beeps” ahead of the time the character appears may be emitted. A network synchronization protocol desirably may be implemented between the distributed computers herein to ensure the various videos are aligned by frame and same scene.

It will be appreciated that whilst present principals have been described with reference to some example embodiments, these are not intended to be limiting, and that various alternative arrangements may be used to implement the subject matter claimed herein.

What is claimed is:

1. A method, comprising:
providing at least a first actor at a first location with a frame of reference while filming the first actor for motion capture (mocap) at least in part by:
presenting at least one reference image on a head-mounted display (HMD) worn by the first actor; and/or
providing retroreflectors on a wall of the first location for reflecting light toward the first actor; and/or
providing visible markers on a floor of the first location.

2. The method of claim 1, comprising presenting at least one reference image on a head-mounted display (HMD) worn by the first actor.

3. The method of claim 1, comprising providing retroreflectors on a wall of the first location for reflecting light toward the first actor.

4. The method of claim 3, comprising providing a light emitter coupled to a HMD worn by the actor, the light reflected from the retroreflectors being from the light emitter.

5. The method of claim 3, comprising providing visible markers on a floor of the first location.

6. The method of claim 1, comprising:
providing at least a second actor at a second location with a frame of reference while filming the second actor for mocap, the first location being geographically distant from the second location; and
presenting mocap from the first and second actors on at least one director display communicating with the first and second locations in a web exercise (WebEx).

7. The method of claim 1, comprising providing the first actor with a frame of reference at least in part using audio played at the first location.

8. The method of claim 4, comprising providing plural light emitters on the HMD.

9. The method of claim 6, comprising synchronizing mocap video of the first and second actors in time.

10. A device comprising:
at least one computer storage that is not a transitory signal and that comprises instructions executable by at least one processor to:
receive from a first camera at a first location motion capture (mocap) video of a first actor;
receive from a second camera at a second location mocap video of a second actor;
synchronize the mocap videos with each other;
merge the mocap videos into a single scene on at least one display at a third location geographically distant from the first and second locations.

11. The device of claim 10, wherein the instructions are executable to:
actuate at least one light emitter at the first location to project reference light against a wall of retroreflectors to reflect reference light toward the first actor.

12. The device of claim 10, wherein the instructions are executable to:
actuate at least one marker on a floor of the first location to reflect reference light toward the first actor.

13. The device of claim 10, wherein the instructions are executable to:
send to a head-mounted display (HMD) worn by the first actor at least one stage instruction.

14. The device of claim 10, comprising the at least one processor.

15. An apparatus comprising:
at least one head-mounted display (HMD) assembly comprising:
at least one processor configured with instructions;
at least one display;
at least one speaker; and
at least one projector configured to project motion capture (mocap) reference light against at least one surface visible to a wearer of the HMD assembly to provide the wearer with spatial reference during mocap.

16. The apparatus of claim 15, wherein the projector is mounted on a boom of the HMD assembly.

17. The apparatus of claim 15, wherein the surface comprises the display of the HMD assembly.

18. The apparatus of claim 15, wherein the surface comprises a wall of retroreflectors.

19. The apparatus of claim 15, comprising at least one wireless transceiver on the HMD assembly for receiving commands from a geographically distant director computer.

20. The apparatus of claim 19, wherein the instructions are executable to:
present the commands on the display and/or play audio on the speaker responsive to the commands.
